(19) United States
(12) Patent Application Publication
(10) Pub. No.: US 2006/0034200 A1
(43) Pub. Date: Feb. 16, 2006

(54) WIRELESS COMMUNICATION SYSTEM, CONTROL STATION, AND TERMINAL STATION

(75) Inventors: Makoto Matsumaru, Tokorozawa-shi, Saitama (JP); Hidemi Usuba, Tokorozawa-shi, Saitama (JP); Wataru Onodera, Tokorozawa-shi, Saitama (JP)

Correspondence Address: DVA/PEC-IPD, 2355 MAIN STREET, SUITE 200, IRVINE, CA, 92614, US

(73) Assignee: PIONEER CORPORATION, Meguro-ku, Tokyo (JP)

(21) Appl. No.: 11/161,244

(22) Filed: Jul. 27, 2005

(30) Foreign Application Priority Data
Jul. 29, 2004 (JP) 2004-222309

(51) Int. Cl. H04B 7/00

(52) U.S. Cl. 370/310

(57) ABSTRACT

The present invention provides a wireless communication system, a control station, and a terminal station whereby a direct link (DL) protocol can be initiated from the control station. A processor has a DL request AP packet generation unit (direct communication request generation instruction unit), which issues an instruction so that a direct link (direct communication) to a terminal station is established according to a notification issued from a packet transfer volume determination circuit when a packet transfer volume stored in a packet transfer volume memory circuit exceeds a predetermined threshold value.

### CROSS REFERENCE TO RELATED APPLICATION

The present application claims priority under the Paris Convention to Japanese Patent Application No. 2004-222309, filed on Jul. 29, 2004.

### BACKGROUND OF THE INVENTION

1. Field of the Invention

The present invention relates to a wireless communication system capable of improving communication traffic, to a control station, and to a terminal station.

2. Description of the Related Art

FIG. 13 is a block diagram showing the functional structure of a control station (base station: access point) AP300 in the conventional wireless LAN system (IEEE 802.11b/a) in common use. The conventional control station 300 is provided with a packet input 40 to which a data packet is fed from a wireless receiver not shown in the diagram, a packet transceiver circuit 30, which sends and receives a packet to and from a processor 20, and a packet output 50, which feeds a packet to a wireless transmitter not shown in the diagram, and has the functional capability of relaying communication between terminal stations.

The processor 20 contains a packet analysis unit 22, which analyzes the format of the packet fed from the packet transceiver circuit 30, and a normal direct link (DL) protocol processing unit 23, which processes a DL request or the like transmitted from a terminal station.

FIG. 14 is a block diagram showing the functional structure of the terminal stations STA401 and 402 in the conventional wireless LAN system in common use. The conventional terminal stations 401 and 402 are provided with a packet input 80 to which a data packet is fed from a wireless receiver not shown in the diagram, a packet transceiver circuit 70, which sends and receives a packet to and from a processor 60, and a packet output 90, which feeds a packet to a wireless transmitter not shown in the diagram.

The processor 60 contains a packet analysis unit 63, which analyzes the format of the packet fed from the packet transceiver circuit 70, a normal DL protocol processing unit 64, which processes a direct link (DL) request or the like transmitted from the control station 300, and a normal DL protocol activation unit 62, which generates the direct link (DL) request transmitted to the control station 300.

In an ad-hoc mode of a common wireless LAN system, the terminal station STA#1 (401) and the terminal station STA#2 (402) can directly communicate with each other without the intervention of the control station, but since the network in this case is separate from that of the control station AP300, communication with the control station AP300 becomes impossible.

FIG. 15 shows the procedure according to IEEE 802.11e when the terminal station STA#1 (401) and the terminal station STA#2 (402) establish a direct link (DL) via the control station AP300.

In a case in which there is a large amount of data communication or the like, the terminal station STA#1 (401) activates the normal direct link (DL) protocol in the normal DL protocol activation unit 62 and transmits a normal DL request packet (1: request) from the normal DL protocol processing unit 64 to the control station AP300.

In the control station AP300, the normal DL request packet thus received is processed by the normal DL protocol processing unit 23, and a normal DL request packet (2: request) is transmitted to the terminal station STA#2 (402).

In the terminal station STA#2 (402), the normal DL request packet thus received is processed by the normal DL protocol processing unit 64, and a normal DL response packet (3: response) is transmitted to the control station AP300.

In the control station AP300, the normal DL response packet thus received is processed by the normal DL protocol processing unit 23, and a normal DL response packet (4: response) is transmitted to the terminal station STA#1 (401).

In the terminal station STA#1 (401), the normal DL response packet thus received is processed by the normal DL protocol processing unit 64, and a direct link (DL) is established (5: probe).

In the conventional sequence as described above, a direct link (DL) is initiated by the terminal station STA issuing a request for a direct link (DL) to the control station AP, but the control station AP cannot subjectively establish a direct link (DL) to a plurality of terminal stations STA.

Since the execution of a direct link (DL) is also dependent upon the application of the terminal station STA, it may not be possible to establish a direct link (DL) for some applications even when the terminal station STA has the functional capability of establishing a direct link (DL).

### SUMMARY OF THE INVENTION

A direct link (DL) protocol is proposed in the new IEEE 802.11e standard whereby communication with the control station AP300 is also possible, and whereby direct communication can be performed between the terminal stations STA401 and 402. In a normal transmission in which a direct link is not established, a packet is first transferred from the terminal station STA#1 to the control station AP300, and a packet is then transferred from the control station AP300 to the terminal station STA#2. In contrast, in a transmission in which a direct link is established, a packet is transferred from the terminal station STA#1 to the terminal station STA#2, and traffic becomes half that of a case in which a direct link is not established. In short, the traffic of the control station and the network is reduced when a direct link (DL) is established.

A wireless communication control station according to the present invention is a wireless communication control station, which relays communication between a first terminal and a second terminal via a wireless communicating component, comprising, a direct communication request generation instruction unit, which generates a direct communication request generation instruction whereby an instruction is issued so as to cause direct communication between the first terminal and the second terminal; and a direct communication request generation instruction transmitter, which transmits the direct communication request generation instruction to the first terminal.

A wireless communication terminal according to another embodiment of the present invention further comprises a direct communication request generation instruction receiving unit, which receives from the control station a direct communication request generation instruction containing terminal specification information, which specifies another terminal; and a direct communication request transmitting component, which transmits a direct communication request to the terminal specified by the terminal specification information via the control station when the direct communication request generation instruction is received.

A wireless communication system according to another embodiment of the present invention is a wireless communication system comprising a first terminal, a second terminal, and a wireless communication control station, which relays communication between the first terminal and the second terminal via the wireless communicating system, wherein the wireless communication control station comprises, a direct communication request generation instruction unit, which generates a direct communication request generation instruction whereby an instruction is issued so as to cause direct communication between the first terminal and the second terminal; and a direct communication request generation instruction transmitter, which transmits the direct communication request generation instruction to the first terminal; and the first terminal comprises, a direct communication request generation instruction receiving unit, which receives from the control station a direct communication request generation instruction containing terminal specification information, which specifies the second terminal; and a direct communication request transmitting component, which transmits a direct communication request to the second terminal via the control station when the direct communication request generation instruction is received.

### BRIEF DESCRIPTION OF THE DRAWINGS

FIG. 1 is a block diagram showing the functional structure of the control station AP in an embodiment of the present invention;

FIG. 2 is a block diagram showing the functional structure of the terminal station STA in an embodiment of the present invention;

FIG. 3 is a flowchart showing the operation of the processor and packet transceiver circuit in the control station AP of the present embodiment;

FIG. 4 is a flowchart showing the operation of the bandwidth monitoring circuit in the control station AP of the present embodiment;

FIG. 5 is a flowchart of the DL request AP packet transmission in the present embodiment;

FIG. 6 shows the direct link (DL) sequence in the present embodiment;

FIG. 7a shows the direct link (DL) protocol packet format;

FIG. 7b shows the direct link (DL) protocol packet format;

FIG. 8a shows the direct link (DL) protocol packet format;

FIG. 8b shows the direct link (DL) protocol packet format;

FIG. 9 is a block diagram showing the functional structure of the control station AP in Example 2;

FIG. 10 a block diagram showing the functional structure of the control station AP in Example 3;

FIG. 11 is a block diagram showing the functional structure of the control station AP in Example 4;

FIG. 12 is a block diagram showing the functional structure of the control station AP in Example 5;

FIG. 13 is a block diagram showing the functional structure of the conventional control station AP;

FIG. 14 is a block diagram showing the functional structure of the conventional terminal station STA; and

FIG. 15 shows the direct link (DL) sequence according to IEEE 802.11e.

### DESCRIPTION OF THE PREFERRED EMBODIMENTS

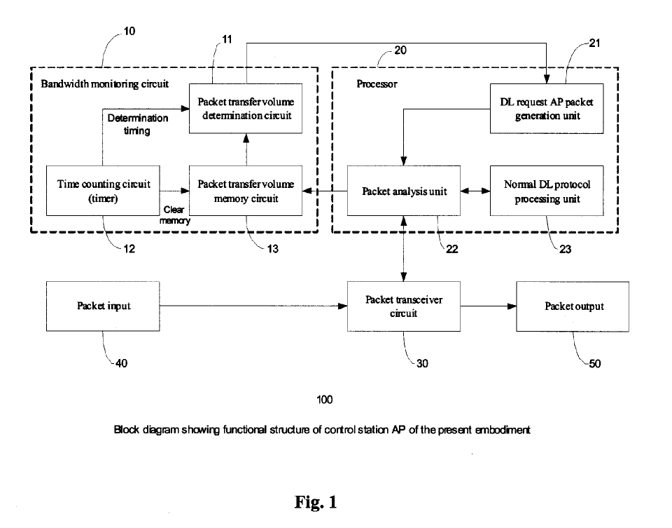

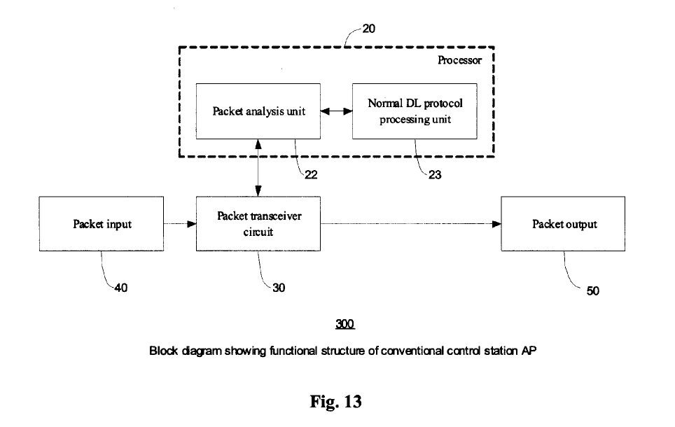

FIG. 1 is a block diagram showing the functional structure of the control station AP100 in an embodiment of the present invention. The control station AP100 of the present embodiment has a configuration in which a bandwidth monitoring circuit 10 and a DL request AP packet generation unit 21 are added to the conventional control station AP300 shown in FIG. 13.

Specifically, the control station AP100 of the present embodiment is provided with a packet input 40 to which a data packet is fed from a wireless receiver not shown in the diagram, a packet transceiver circuit 30 (data communication unit), which sends and receives a packet to and from a processor 20, a packet output 50, which feeds a packet to a wireless transmitter not shown in the diagram, and a bandwidth monitoring circuit 10.

The bandwidth monitoring circuit 10 is provided with a packet transfer volume memory circuit 13, which stores the packet volume transferred in a predetermined period of time between terminal stations, a time counting circuit (timer) 12, which generates a determination timing at predetermined time intervals and clearing the packet transfer volume memory circuit 13 at predetermined time intervals, and a packet transfer volume determination circuit 11, which determines whether the packet transfer volume stored in the packet transfer volume memory circuit 13 exceeds a predetermined threshold value.

The processor 20 is provided with a packet analysis unit 22, which analyzes the format of the packet fed from the packet transceiver circuit 30, a normal DL protocol processing unit 23, which processes a direct link (DL) request (direct communication request) or the like transmitted from a terminal station, and a DL request AP packet generation unit 21 (direct communication request generation instruction unit), which generates a DL request AP packet (direct communication request generation instruction), which issues an instruction so that a direct link (DL: direct communication) to a terminal station is established according to a notification issued from the packet transfer volume determination circuit 11 when the packet transfer volume stored in the packet transfer volume memory circuit 13 exceeds the predetermined threshold value.

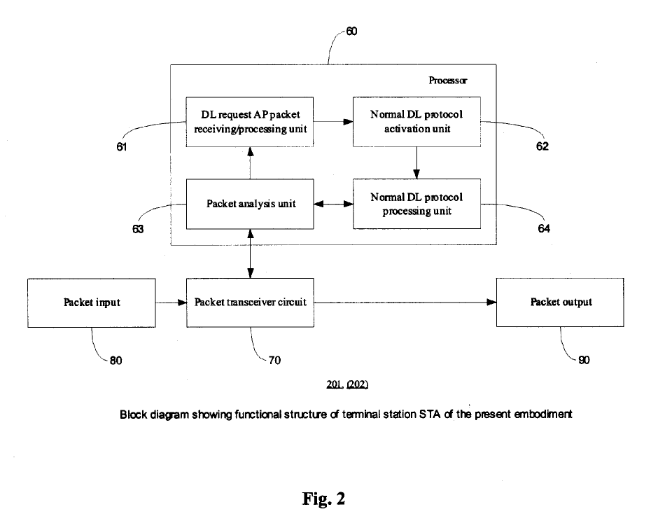

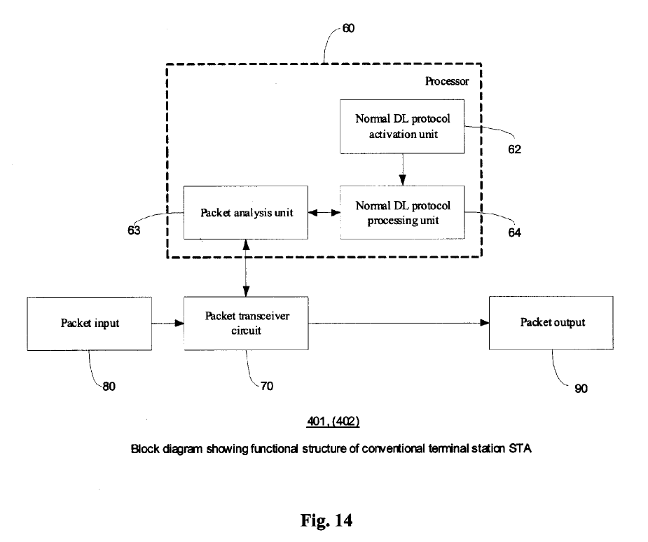

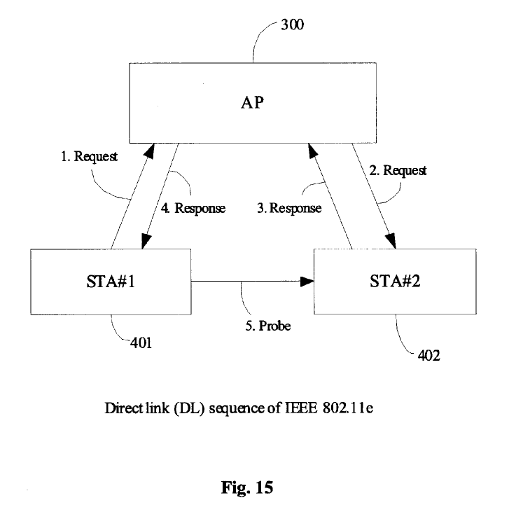

FIG. 2 is a block diagram showing the functional structure of the terminal stations STA201 and 202 in an embodiment of the present invention. The terminal stations STA201 and 202 of the present embodiment have a configuration in which a DL request AP packet receiving/processing unit 61 is added to the conventional terminal stations STA401 and 402 shown in FIG. 14.

Specifically, the terminal stations STA201 and 202 of the present embodiment are provided with a packet input 80 to which a data packet is fed from a wireless receiver not shown in the diagram, a packet transceiver circuit 70, which sends and receives a packet to and from a processor 60, and a packet output 90, which feeds a packet to a wireless transmitter not shown in the diagram.

The processor 60 is provided with a packet analysis unit 63, which analyzes the format of the packet fed from the packet transceiver circuit 70, a normal DL protocol processing unit 64, which processes a direct link (DL) request or the like transmitted from the control station 100, a normal DL protocol activation unit 62 (direct communication request generation unit), which generates the direct link (DL) request transmitted to the control station 100, and a DL request AP packet receiving/processing unit 61 (direct communication request generation instruction processing unit), which generates a direct link (DL) request to the normal DL protocol processing unit 64 according to a direct link (DL) request received from the control station 100.

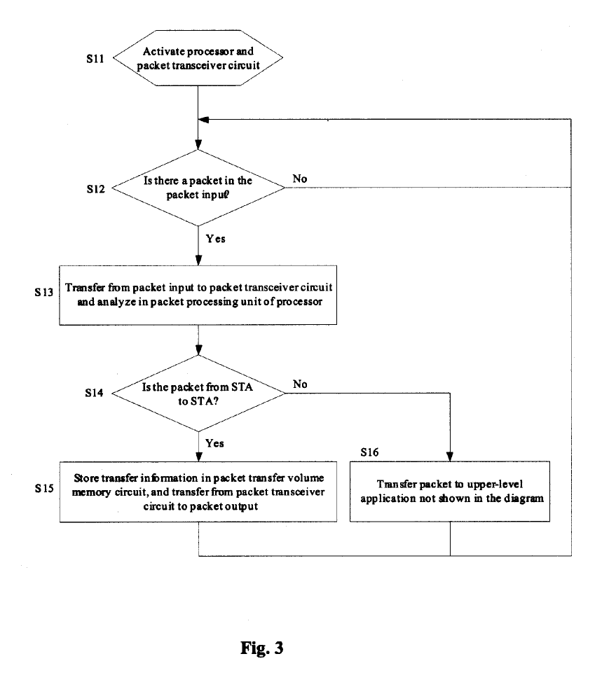

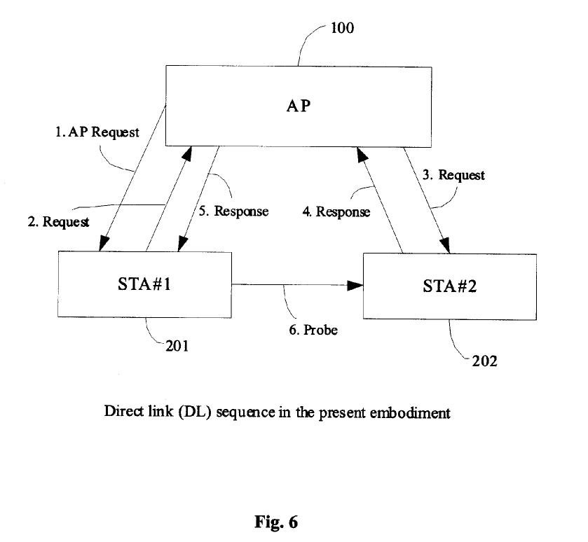

The operations of the blocks in FIGS. 1 and 2 will be described hereinafter using flowcharts and state diagrams. The flowchart in FIG. 3 shows the operation of the processor 20 and packet transceiver circuit 30 in the control station AP100 of the present embodiment. FIG. 6 shows the direct link (DL) sequence in the control station AP100, terminal station STA#1 (201), and terminal station STA#2 (202).

As shown in FIG. 3, when the processor 20 and packet transceiver circuit 30 of the control station AP100 are activated (step S11), a standby state occurs until a packet is received in the packet input 40 (step S12).

When a packet is received, it is transferred to the packet transceiver circuit 30 and analyzed by the packet analysis unit 22 of the processor 20 (step S13).

For example, when a packet is transferred from terminal station STA#1 (201) to terminal station STA#2 (202) (“Yes” in step S14), transfer information is stored by the packet transfer volume memory circuit 13, transferred from the packet transceiver circuit 30 to the packet output 50 (step S15), and then transmitted to terminal station STA#2 (202). The transfer information is the packet volume and information of the terminal stations STA that are transmitting and receiving.

In step S14, when a packet is transferred from terminal station STA#1 (201) to the control station AP100 (“No”), the packet is transferred to the top-level application of the control station AP100 (step S16), the process returns to step S12, and a standby state occurs again until the packet is received in the packet input 40. The operation described above is that of the processor 20 and the packet transceiver circuit 30.

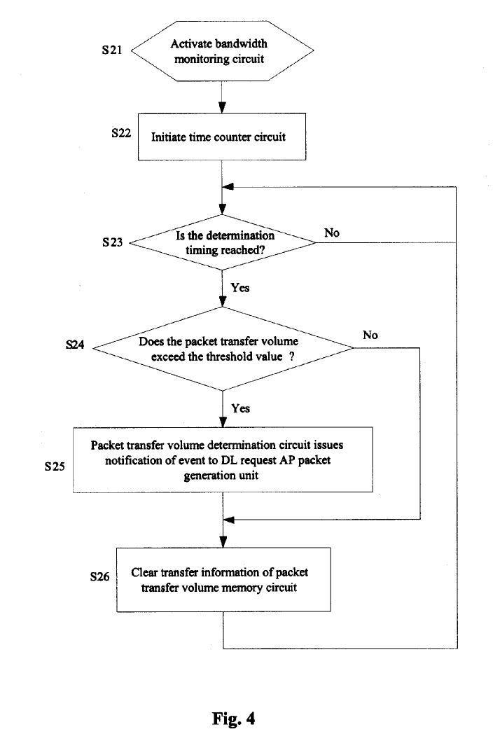

The operations of the blocks of the control station AP100 will next be described using the flowchart. The operation of the bandwidth monitoring circuit 10 of the control station AP100 is shown in the flowchart in FIG. 4.

When the bandwidth monitoring circuit 10 is activated (step S21), the time counting circuit (timer) 12 begins counting up (step S22), and a standby state occurs until the determination timing is reached (step S23).

When the determination timing is reached, the packet transfer volume determination circuit 11 performs a determination. The determination method involves ascertaining whether the packet transfer volume of the packet transfer volume memory circuit 13 exceeds the threshold value (step S24).

When the threshold value is exceeded (“Yes”), notification of an event is issued to the DL request AP packet generation unit 21 of the processor 20 (step S25). After the determination timing, the transfer information of the packet transfer volume memory circuit 13 is cleared (step S26), the process returns to step S23, and a standby state occurs until the determination timing is reached. The operation described above is that of the bandwidth monitoring circuit 10.

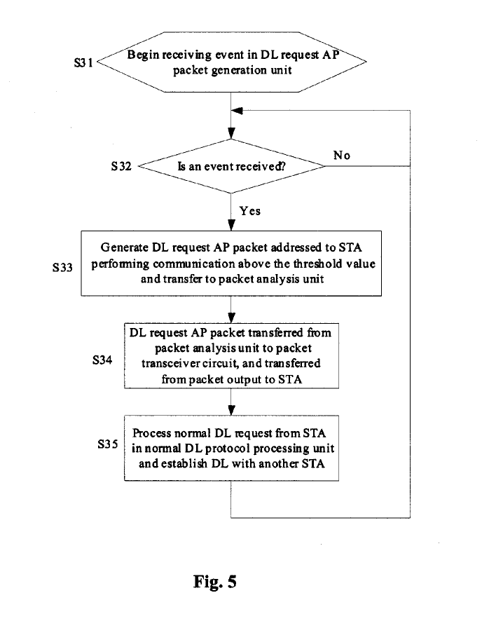

The operations of the blocks of the control station AP100 will next be described using a flowchart and state diagram. The flowchart in FIG. 5 shows the DL request AP packet transmission and the direct link (DL) protocol.

The DL request AP packet generation unit 21 of the processor 20 is in standby until notification of an event is received from the packet transfer volume determination circuit 11 (step S31). When notification of an event is received (“Yes” in step S32), a DL request AP packet addressed to the terminal station STA that is performing communication in excess of the threshold value (for example, terminal station STA#1 (201) in FIG. 6) is generated from the event information. The packet thus generated is transferred to the packet analysis unit 22 (step S33).

The DL request AP packet is transferred from the packet analysis unit 22 to the packet transceiver circuit 30, and is transmitted from the packet output 50 to the terminal station STA#1 (201) (step S34; 1: AP request of FIG. 6: direct communication request generation instruction).

In terminal station STA#1 (201), the DL request AP packet is analyzed in the packet analysis unit 63, the normal direct link (DL) protocol is activated in the normal DL protocol activation unit 62, and a normal DL request packet (2: request: direct communication request) is transmitted from the normal DL protocol processing unit 64 to the control station AP100.

In the control station AP100, the normal DL request packet thus received is processed by the normal DL protocol processing unit 23, and the normal DL request packet (3: request) is transmitted to the terminal station STA#2 (202).

In terminal station STA#2 (202), the normal DL request packet thus received is processed by the normal DL protocol processing unit 64, and a normal DL response packet (4: response) is transmitted to the control station AP100.

In the control station AP100, the normal DL response packet thus received is processed by the normal DL protocol processing unit 23, and the normal DL response packet (5: response) is transmitted to the terminal station STA#1 (201).

In terminal station STA#1 (201), the normal DL response packet thus received is processed by the normal DL protocol processing unit 64, and a direct link (DL) is established (step S35; 6: probe). The control station AP100 returns to step S32 and enters a standby state until an event is received. The operation described above is that of the DL request AP packet transmission and the direct link (DL) protocol.

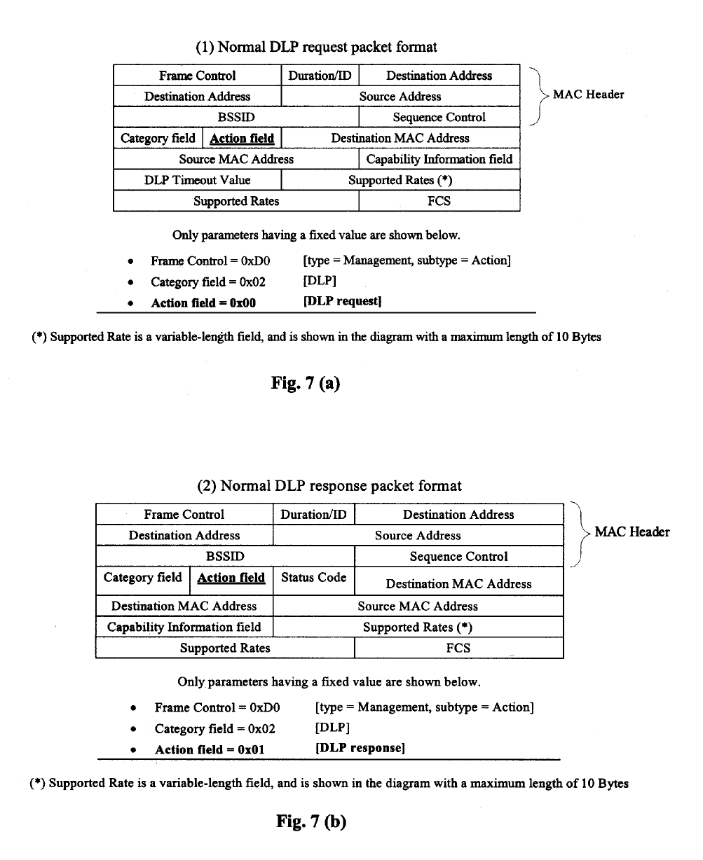

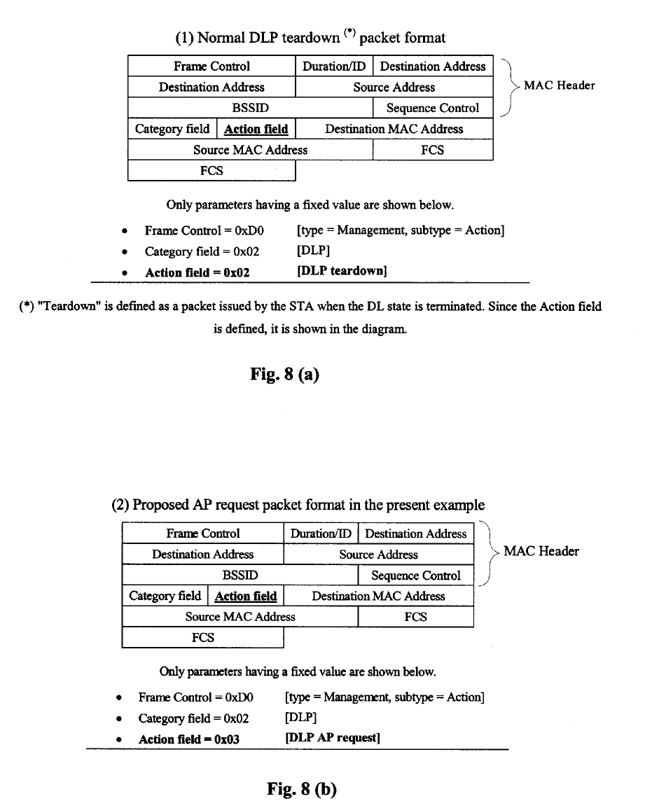

FIGS. 7 and 8 show the packet format of the direct link (DL) protocol. The normal DLP (Direct Link Protocol) request packet format of FIG. 7a is the format of the requests indicated by the numbers 2 and 3 in FIG. 6, and the action field thereof is defined as 0×00. The normal DLP response packet format of FIG. 7b is the format of the responses indicated by the numbers 4 and 5 in FIG. 6, and the action field thereof is defined as 0×01.

The normal DLP teardown packet format of FIG. 8a is the format of the packet issued by the terminal station STA when the direct link is terminated, and the action field thereof is defined as 0×02. FIG. 8b shows the packet format (1: AP request in FIG. 6) of the AP request issued from the control station 100 according to the present embodiment, and the action field thereof is defined, for example, as 0×03.

According to the present embodiment, by adding the functional capability of requesting initiation of a direct link (DL) in the control station AP100, the processing load in the control station AP100 can be reduced, and communication traffic can be improved.

Since a configuration is also adopted in the present embodiment that can be substantially implemented by software processing in the processor 20 without modification of hardware, this structure can be built into existing LSI.

In Example 1, the direct link (DL) initiation request from the control station AP100 is described to be performed at a specific time with respect to the terminal stations STA201 and 202 that have transmitted a specific data volume, but a configuration may also be adopted whereby monitoring is performed for a specific time, and direct link (DL) initiation is requested from the control station AP100 with respect to the terminal stations STA201 and 202 for which the data volume is large when the resources remaining in the wireless communication bandwidth are reduced below a certain amount.

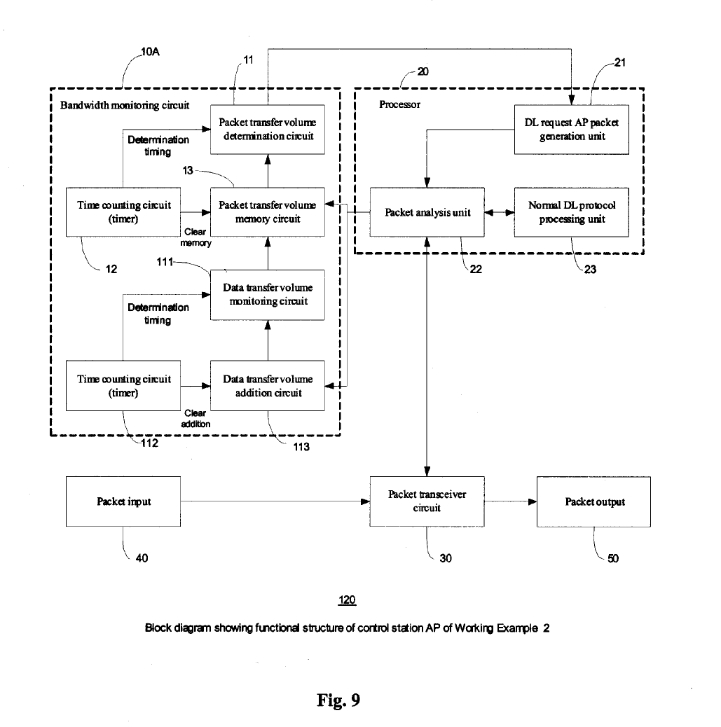

FIG. 9 is a block diagram showing the functional structure of the control station AP120 of Example 2. In the present example, the control station AP120 is provided with a bandwidth monitoring circuit 10A, and initiation of a direct link is determined within this bandwidth monitoring circuit 10A. Specifically, the bandwidth monitoring circuit 10A is provided with a packet transfer volume determination circuit 11, a time counting circuit (timer) 12, a packet transfer volume memory circuit 13, a data transfer volume monitoring circuit 111, a time counting circuit 112, and a data transfer volume addition circuit 113.

The transfer volume addition circuit 113 continues to add the data volume of all of the packets transferred during a certain period of time according to the time count of the time counting circuit 112. Then the time counting circuit 112 outputs a determination timing signal to the data transfer volume monitoring circuit 111 when the time counting is completed. The data transfer volume monitoring circuit 111 then monitors whether the added data volume exceeds, for example, 80% of the maximum data volume transmittable in a certain period of time. Since this monitoring by the data transfer volume monitoring circuit 111 does not include the information of the packet transfer origin and transfer destination, the processing load thereof is small.

When the added volume exceeds the predetermined data volume in the abovementioned monitoring, the data transfer volume monitoring circuit 111 sends a packet transfer volume storage instruction to the packet transfer volume memory circuit 13, and performs monitoring that includes the packet transfer origin and transfer destination for a certain period of time counted by the time counting circuit (timer) 12 in the same manner as in FIG. 1 (the processing load in this case is large). By this monitoring, the packet transfer volume determination circuit 111 specifies the terminal station STA for which the data volume is largest, and requests initiation of a direct link (DL) to that terminal station STA. The same component may be used as the time counting circuit 12 and the time counting circuit 112.

Effects are obtained by the present embodiment whereby only the transmission bandwidth is monitored, there is no need to continually monitor/store the data volumes of the terminal stations STA, and the amount of processing is reduced.

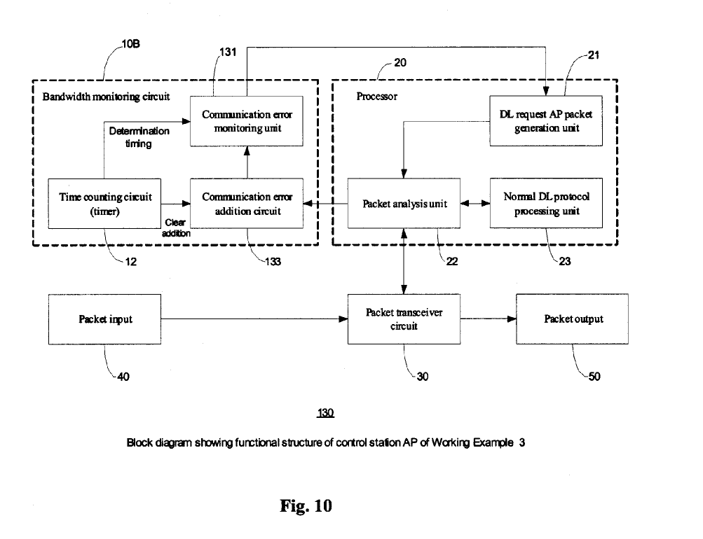

FIG. 10 is a block diagram showing the functional structure of the control station AP130 of Example 3. A bandwidth monitoring circuit 10B is provided in the present embodiment, and this bandwidth monitoring circuit 10B performs a direct link (DL) initiation request when there is an increase in communication errors with the control station AP130. In this case, the method of determining if an error has occurred in communication with the control station AP130 involves the communication error adding circuit 133 determining that an error has occurred during transfer of a packet from terminal station STA#1 to the control station AP, and then to terminal station STA#2 when there is no ACK response from terminal station STA#2 with respect to the packet transferred to terminal station STA#2 in the portion of the transfer in which the packet is transferred from the control station AP to terminal station STA#2, and adds the number of errors. The communication error number monitoring circuit 131 monitors the number of communication errors in a certain period of time, and requests initiation of a direct link (DL) to terminal station STA#1 when the number of errors exceeds a certain threshold value.

Since re-transmission due to transmission errors is no longer performed via the control station AP in this configuration, effects are obtained whereby traffic is reduced, since the terminal stations STA are also separate from the control station AP. Also, because an error occurs when the terminal station STA are separate from the control station AP, errors no longer occur if the distance between terminal stations STA is reduced by switching to communication between terminal stations STA.

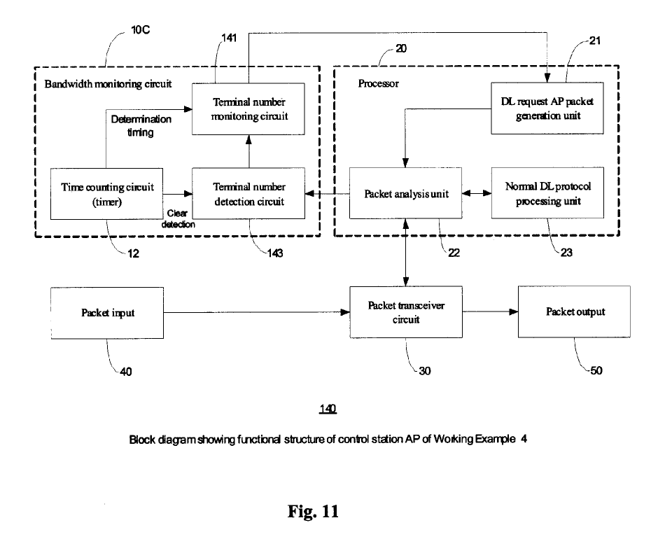

FIG. 11 is a block diagram showing the functional structure of the control station AP140 of Example 4. A bandwidth monitoring circuit 10C is provided in the present example, and this bandwidth monitoring circuit 10C requests initiation of a direct link (DL) when the number of terminal stations STA participating in the network increases.

The terminal stations STA participate in the network administrated by the control station AP according to a procedure referred to as association. Therefore, the control station AP perceives the number of terminal stations STA that are participating in the network with a terminal number detection circuit 143. For example, a configuration is adopted whereby a counter register, which counts the number of terminals, a reference register, and a comparator are provided to the control station STA, and the value of the counter register is increased by one when a terminal station STA is associated with the control station AP. When the value of the counter register is compared with the value (10, for example) set in advance in the reference register and the values match, the comparator outputs a signal to the terminal number monitoring circuit 141, whereby monitoring is performed that includes the packet transfer origin and transfer destination in a certain period of time when 10 or more terminal stations are participating in the network, for example. By this monitoring, the terminal station STA for which the data volume is largest can be specified, and initiation of a direct link (DL) to that terminal station STA can be requested.

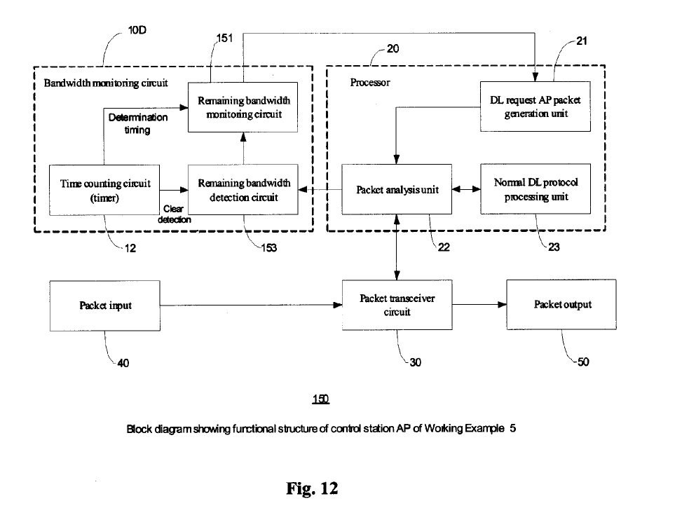

FIG. 12 is a block diagram showing the functional structure of the control station AP150 of Example 5. A synchronous transmission system (HCCA: HCF (Hybrid Coordination Function) Controlled Channel Access) is newly supported by IEEE 802.11e. In general, synchronously transmitting terminal stations STA transmit a request packet, which reserves an amount of bandwidth commensurate with the data volume used to the control station AP150, reserve the bandwidth, and initiate data transmission.

The control station AP150 has a bandwidth monitoring circuit 10D, and this bandwidth monitoring circuit 10D detects the remaining bandwidth by a remaining bandwidth detection circuit 153. When there is little remaining bandwidth (20% remaining, for example), initiation is requested of a direct link (DL) to the terminal station STA for which the greatest amount of bandwidth is reserved by a remaining bandwidth monitoring circuit 151. With this method, there is no need to monitor packet transfer, and the processing load can be kept low.

The present invention is capable of effectively utilizing bandwidth in a wireless environment, improving traffic, and enhancing communication quality even when there is little throughput margin in a product adapted to a wireless LAN based on IEEE 802.11e.

What is claimed is:

1. A control station, which relays communication between a first terminal and a second terminal via a wireless communicating system, comprising:
a direct communication request generation instruction unit, which generates a direct communication request generation instruction whereby an instruction is issued so as to cause a direct communication between the first terminal and the second terminal; and
a direct communication request generation instruction transmitter, which transmits the direct communication request generation instruction to the first terminal.

2. The control station according to claim 1, wherein the direct communication request transmitted from the first terminal is transmitted to the second terminal according to the direct communication request generation instruction transmitted to the first terminal.

3. The control station according to claim 1, further comprising a transfer volume monitoring unit, which monitors a number of relay packets per predetermined time between the first and second terminals, wherein
the direct communication request generation instruction unit generates the direct communication request generation instruction according to the number of relay packets per the predetermined time.

4. The control station according to claim 3, further comprising a data volume addition component, which counts a total amount of data relayed within a pre determined time, wherein
the transfer volume monitoring unit initiates monitoring according to the counted results of the data volume addition component.

5. The control station according to claim 3, further comprising a terminal number detection component, which detects a number of terminals in communication via the control station, wherein
the transfer volume monitoring unit initiates monitoring according to the number of terminals thus detected.

6. The control station according to claim 4, wherein the direct communication request generation instruction unit generates a direct communication request generation instruction, which instructs that direct communication occur between terminals having the highest number of relay packets per predetermined time.

7. The control station according to claim 1, further comprising a communication error counting component, which counts communication errors between the first terminal and the second terminal, wherein
the direct communication request generation instruction unit generates a direct communication request generation instruction according to the number of communication errors in a predetermined period of time.

8. A communication terminal comprising:
a direct communication request generation instruction receiving unit, which receives from a control station a direct communication request generation instruction containing terminal specification information, which specifies another terminal; and
a direct communication request transmitting component, which transmits a direct communication request to a terminal specified by the terminal specification information via the control station when the direct communication request generation instruction is received.

9. A communication system comprising:
a first terminal;
a second terminal; and
a wireless communication control station, which relays communication between the first terminal and the second terminal via the communicating system;
wherein the wireless communication control station comprises, a direct communication request generation instruction unit, which generates a direct communication request generation instruction whereby an instruction is issued so as to cause direct communication between the first terminal and the second terminal, and a direct communication request generation instruction transmitter, which transmits the direct communication request generation instruction to the first terminal; and
wherein the first terminal comprises, a direct communication request generation instruction receiving unit, which receives from the control station a direct communication request generation instruction containing terminal specification information, which specifies the second terminal, and a direct communication request transmitting component, which transmits a direct communication request to the second terminal via the control station when the direct communication request generation instruction is received.
